(19) United States
(12) Patent Application Publication
(10) Pub. No.: US 2012/0085026 A1
(43) Pub. Date: Apr. 12, 2012

(54) EXPANDIBLE AEROPONIC GROW SYSTEM

(76) Inventor: David W. Morris, Wood Village, OR (US)

(21) Appl. No.: 12/903,059

(22) Filed: Oct. 12, 2010

(51) Int. Cl. A01G 31/02

(52) U.S. Cl. 47/62 A

(57) ABSTRACT

An expandible aeroponic grow system capable of adding additional stay systems horizontally or vertically to the support structure of the base grow system so as to utilize a common pump, valves, filter, drain, supply tank and nutrient supply media. It utilizes a root spray that has an adjustable pattern to accommodate different placements of plants in the enclosed spray tray. It also uses a spray pattern designed to maximize the water and nutrient delivery to the plant's entire root as well as increasing the oxygen content of the nutrient media.

### BACKGROUND OF THE INVENTION

The present invention relates to a extremely versatile and expandable system of growing vegetation with monomial contact between the vegetation and the support structure so as to allow for 100% of the plant to be entirely in air. More particularly, to a structural system of holding and nurturing the vegetation that is able to adapt to the different requirements of the cloning, vegetation and flowering stages of growth during long-term aeroponic cultivation.

The growth of vegetation proceeds through different stages that have differing physical, light and nutrient requirements for the plants. Most growers have different bedding structures and environments into which the plants must constantly be switched. Since aeroponics rely on the nutrients being brought to the plant's root structure it is critical that all of the plant's root is adequately satiated and that there is a minimal amount of nutrient waste. Since much of a premium vegetation's cultivation is done indoors, space is at a premium. it would be an advantage to be able to stack or chain together multiple systems such that single components may be utilized for multiple systems.

Henceforth, an expandible aeroponic grow system would fulfill a long felt need in the vegetation cultivation industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide an energy and nutrient efficient aeroponic grow system that is capable of interconnected physical expansion, horizontally or vertically.

It has many of the advantages mentioned heretofore and many novel features that result in a new expandible aeroponic grow system which is not anticipated, rendered obvious, suggested, or even implied by any of the prior art, either alone or in any combination thereof.

In accordance with the invention, an object of the present invention is to provide an improved aeroponic grow system capable of horizontal or vertical expansion.

It is another object of this invention to provide an improved expandible aeroponic grow system capable of meeting or exceeding current expectations for plant growth and dramatically reduced rates of plant loss due to pathogens and disease.

It is a further object of this invention to provide an expandible aeroponic grow system capable of adaptation for maximum growth during the various phases of plant growth and to accommodate for changes in the number of plants being cultivated.

It is still a further object of this invention to provide for an expandible aeroponic grow system that can maximize the amount of water and oxygen delivered to each plant's root regardless of the physical location of the plant within the plant's grow tray.

It is yet a further object of this invention to provide an expandible aeroponic grow system that uses a minimum of water and nutrients and yet can achieve maximum plant growth in contracted grow periods.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a perspective view of the expandible aeroponic grow system illustrating all of the elements;

FIG. 2 is a perspective view of the expandible aeroponic grow system coupled horizontally to a substantially similar expandible aeroponic grow system;

FIG. 3 is a perspective view of the expandible aeroponic grow system coupled to seven substantially similar expandible aeroponic grow systems both vertically and horizontally;

FIG. 4 is a top perspective view of the aeroponics enclosure with the tray lid removed;

FIG. 5 is a top view of the aeroponics enclosure with the tray lid removed and the spray headers in a first configuration;

FIG. 6 is a top view of the aeroponics enclosure with the tray lid removed and the spray headers in a second configuration;

FIG. 7 is a side perspective view of the spray header;

FIG. 8 is a top perspective view of the cloning lid with cloning pucks installed therein;

FIG. 9 is a top view of the cloning lid without cloning pucks installed;

FIG. 10 is a perspective view of the vegetative or flowering lid;

FIG. 11 is a side view of the spray head;

FIG. 12 is a perspective view of a cloning puck; and

FIG. 13 is a perspective view of the alternate embodiment spray header.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. Although illustrated and described in the context of a single plant aeroponic grow system, a multiple plant aeroponic grow system and horizontal and vertical groupings of a aeroponic grow system, the invention is capable of other embodiments and of being practiced and carried out in various ways. Also, it is to be understood that the phraseology and terminology employed herein are for the purpose of descriptions and should not be regarded as limiting.

The basic principle of aeroponic growing for vegitation is to grow plants suspended in a semi-closed environment, timely spraying the plant's roots which dangle into an aeroponic enclosure with an atomized, nutrient-rich fluid media solution. Oxygen in the rhizosphere (root zone) is necessary for healthy plant growth. As aeroponics is conducted in air combined with micro-droplets of water, almost any plant can grow to maturity in air with a plentiful supply of oxygen, water and nutrients. The plant structure is held in place on the lid of the enclosure by a closed cell foam cloning puck that surrounds the lower stem and is inserted into an opening in the aeroponic chamber, The leaves and crown, (“canopy”), extend above to receive light. When the plant reaches a certain size it is removed from the cloning puck and put into a larger retention device from which its watering and sunning continues. In this way the root systems are free of constraints surrounding the stem and root systems. Physical contact is minimized so that it does not hinder natural growth and root expansion or access to pure water, air exchange and disease-free conditions.

This aeroponic grow system has an adjustable watering system that flings the fluid media (water/nutrient mix) onto the parts of the dangling roots that are directly inline and then “splatts” the remainder against the aeroponic enclosure's side walls to break the mixture into smaller droplets which have a larger surface area and can absorb and deliver more oxygen to the plant's roots. The splatted fluid bounces off of the enclosure's side walls and reach the back areas of the vegetation's roots that are not in direct line with the flinging fluid media. The rotatability of the spray header along with the use of several angularly placed spinners to fling the fluid media allows the user to change and optimize the header's position for different placements of vegetation in the enclosure during different growth stages.

When aeropinically growing vegetation in a nutrient rich mist environment without the use of soil or an aggregate medium, the rate of growth is largely dependant on the percentage of the root that is able to be sufficiently misted. The following system allows for the flexibility in the placement of the spray heads and spray patterns about the root structures. This is very important as the plant progresses from the cloning/propagation stage to the vegetative stage and lastly to the flowering stage.

The system described above also allows for minimization of nutrient rich fluid media solution, optimized access to air, improved nutrient feeding, enhanced pathogen control, pest control and disease prevention so that the plants may grow healthier and quicker than plants grown in a medium. This aeroponic growing system is especially well adapted for vegetative cutting propagation or “cloning.” This reduced numerous labor steps associated with the various stages of plantings into soil as well eliminating transplant shock which is a setback to normal growth.

Studies have been conducted on the effects of dissolved oxygen concentrations on the formation of adventitious roots looking at three separate zones within the root area. The ends of the roots were submerged in nutrient, the middle of the root section was misted with nutrient and the upper portion was above the mist. Results showed that dissolved O2 is essential to root formation, but went on to show that for the three O2 concentrations tested, the number of roots and root length were always greater in the central misted section than either the submersed section or the un-misted section. This system attempts to maximize the growth of healthy vegetation by optimization of this misting with finer droplets having more oxygen that reach 360 degrees of the plant root.

Sterilization is simple in the event a pathogen does materialize. The fluid media may be pumped out of the vessel and replaced with a bleach or other disinfectant and then the system run as normal. After removal of the disinfectant and rinsing the aeroponic grow system is ready to go.

Water droplet size is crucial for sustaining aeroponic growth. Too large a water droplet means less oxygen is available to the root system. Too fine a water droplet, such as those generated by an ultrasonic mister, produce excessive root hair without developing a lateral root system for sustained growth in an aeroponic system. Through the use of a throttling valve the pump's discharge pressure and volume may be adjusted to optimize the speed of the spinners and hence the water droplet size. This may be continually adjusted since as the plant grows there is more pressure required to force the mist into the denser root system.

A problem with continual spraying of a nutrient rich solution is the degradation of the misting spray due to mineralization of mist heads. In this system the mist heads are threaded into the spray header and may be replaced or removed for cleaning.

Since the nutrient rich fluid media must never get too warm, a non-submersible pump was utilized outside of the collection vessel to disperse its heat into the air rather than using a submersible pump.

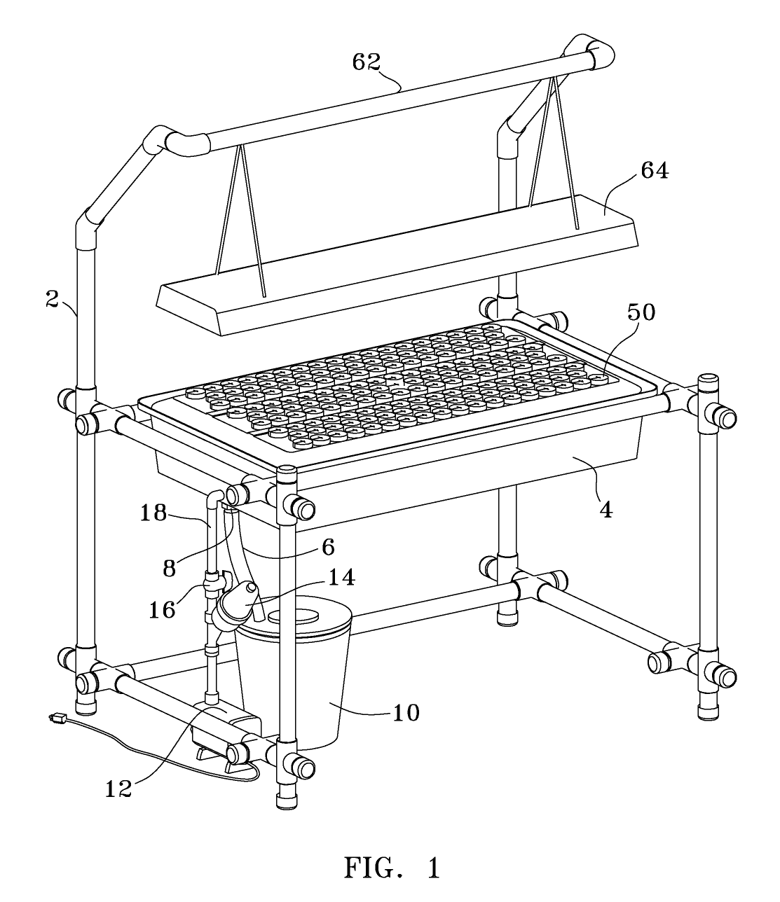

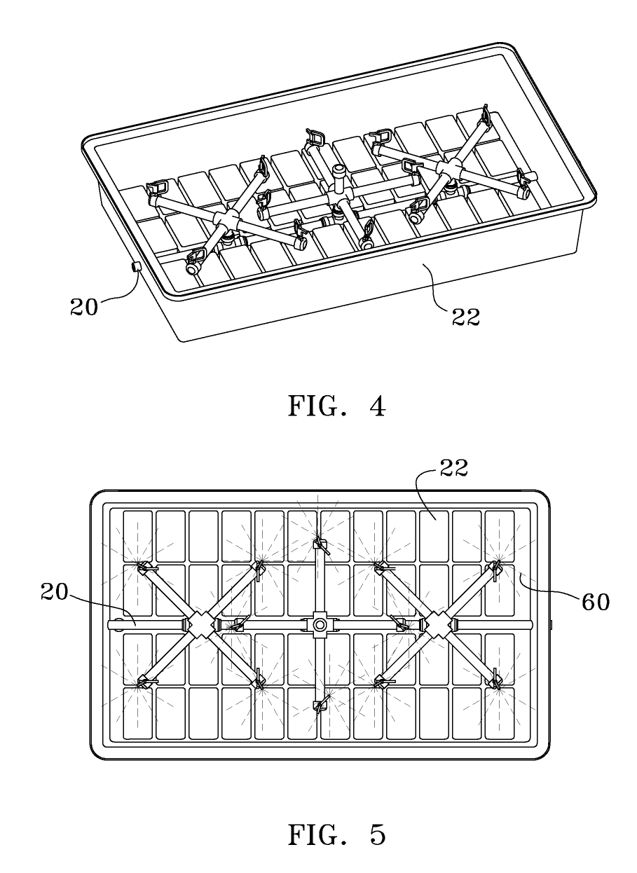

Looking at FIG. 1 it can be seen that the expandible aeroponic grow system has an expandible tubular support structure 2 that holds an aeroponic enclosure 4 in an elevated horizontal configuration such that a drain tube 6 connected by a drain fitting 8 to the bottom of the aeroponic enclosure 4 may return nutrient rich fluid media to the collection vessel 10. A suction tube (not visible) connects the collection vessel 10 to the pump 12 which discharges the fluid through an inline filter 14 and a valve 16 via discharge tube 18 to the distribution manifold 20 which lies generally centrally along the linear axis of the enclosure tray 22 (FIG. 4). The distribution manifold 20 is made of several lengths of tubing/piping connected in series to three rotatable spray headers 24 (FIG. 7) that extend upward from the manifold 20. Each connection is facilitated by push connectors 26. The last length of tubing/piping in the distribution manifold 20 is sealed at its end. This style of fabrication allows for any number of the standardized spray headers 24 to be located in any desired configuration to fit into any sized aeroponic enclosure. (In the simplest embodiment this would be just one spray header centralized in one bucket.)

Looking at FIGS. 7 and 11 it can be seen that the spray header 24 has a rotatable stub shaft 28 (rotatable by virtue of the rotatable, sealable design of the push fittings 26) that is connected to a central tee 30 from which extends four header tubes 32. Each header tube's proximate end is affixed to the central tee 30 and their distal ends have a cap 34 with an orifice threaded therethrough to accept a matingly conformed spinnable spray nozzle 36. The spray nozzle 36 has a pivot bracket 38 that houses a rotating spinner 40. From the bottom of the pivot bracket 38 projects normally a threaded peg 42 for connection to the cap 34. An optional support peg 46 may extend centrally from the spray header 24 to aid in the support of the tray lids. The overall configuration of the spray header 24 is that of a cross which can be rotated about the stub shaft 28. When three spray headers 24 are connected to the distribution manifold they may be placed in +x+ or x+x configurations depending on the desired coverage pattern for whichever state of growth the vegetation is in. This allows the user to maximize both the spray pattern coverage and the oxygen content of the fluid media.

It is to be noted that the support structure has uneven length legs on the different sides so that the fluid media drains to the lower end of the tray 22 where the drain fitting 8 is located. The support structure in a single enclosure embodiment has a light support bar 62 extending horizontally therefrom that is adapted to support a grow lamp 64.

In operation, when pressurized fluid medial reaches the cap 34 pressure forces the fluid up through the hollow threaded peg 42 into the spinner 40 which is rotatably housed in the into the pivot bracket 38 of the spray nozzle 36. The spinner 40 has a curved path formed thereon from which the water escapes, thereby spinning the spinner 40 in circles propelling the fluid media in a circular pattern.

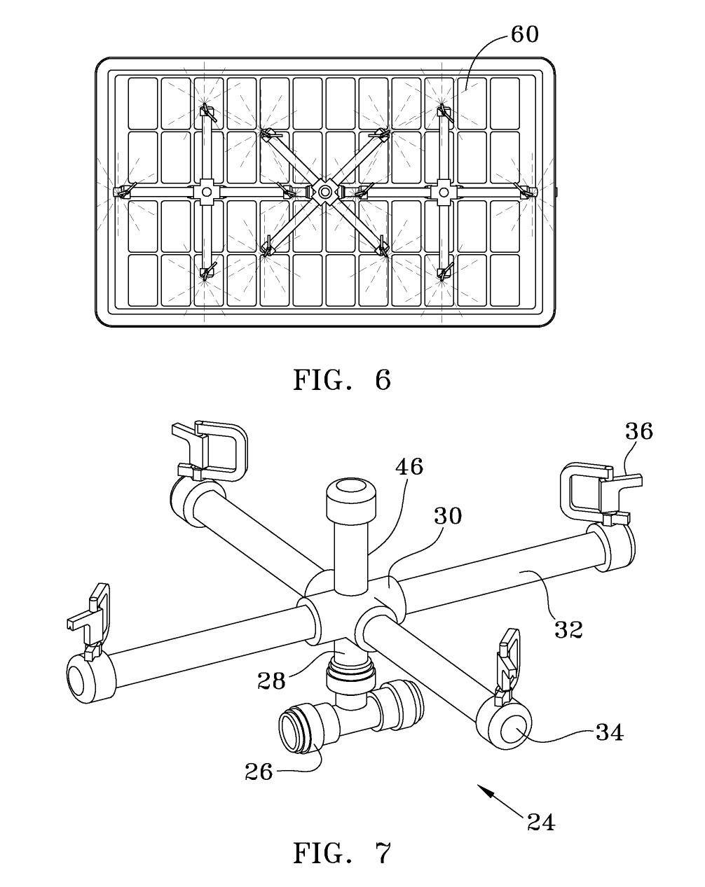

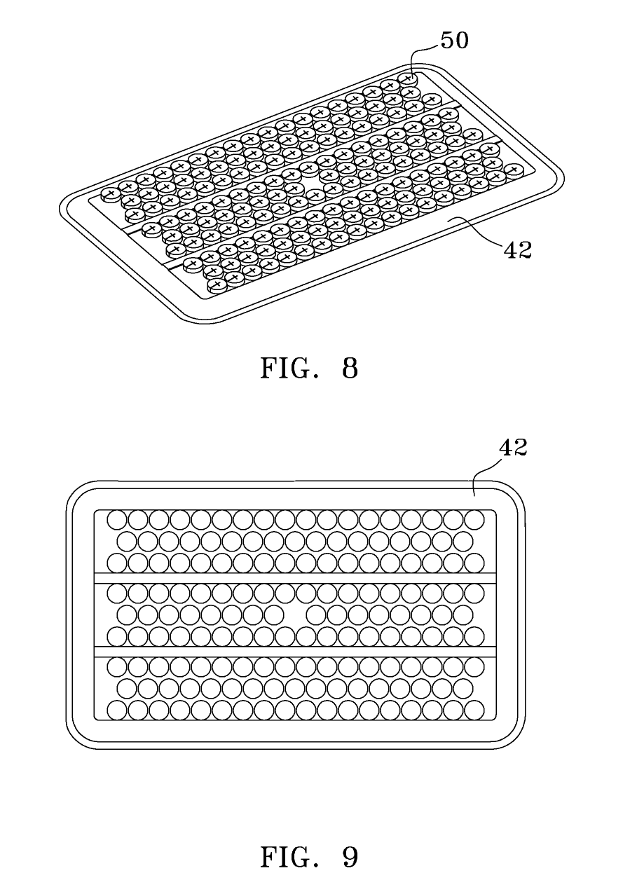

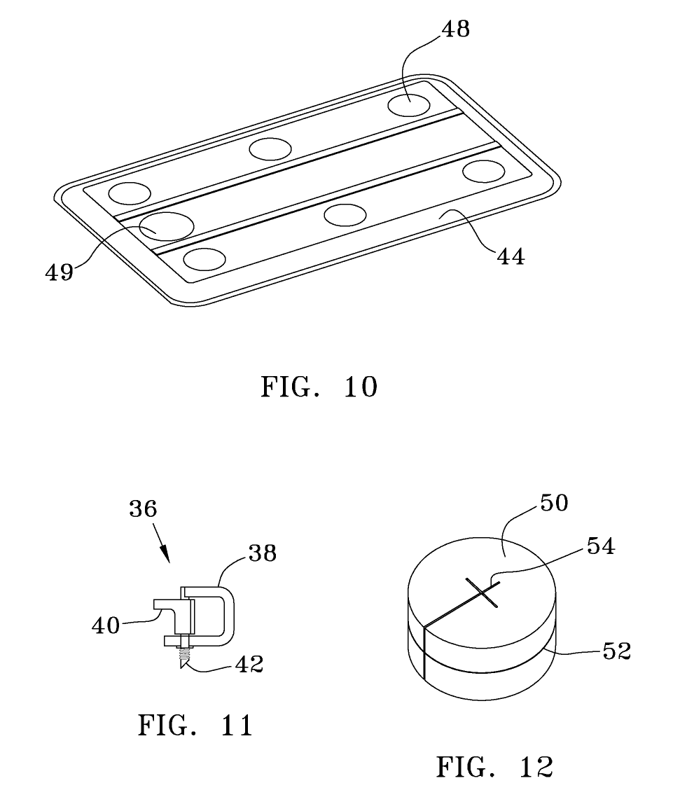

As can be seen by looking at FIGS. 5 and 6 the spray patterns 60 from the different positions of the spray header 24 will accommodate different placements of different sized plants and still mist all 360 degrees of the root. These different placements can be seen in the different opening in the cloning enclosure lid 42 (FIGS. 8 and 9) and the vegetative lid 44 (FIG. 10) can be seen. The design of the spray header allows for the collisions of the fluid media against the walls of the tray 22 and in fact uses this as a method to further break up the water droplets of the mist, allow them to pick up more oxygen and to deliver them to the areas of the root that are not in direct line with the spray nozzle 36.

It is to be noted that the aeroponic enclosure 4 is made of a tray 22 and a lid (42 or 44) which is opaque and watertight. The lids will seal to the tray about their perimeter and will have a plurality of plant orifices 48 to house cloning pucks 50 or root netting to support the vegetation. Access ports 49 may be provided to access components inside the enclosure 4 but when not in use will have sealable caps thereon. The cloning pucks 50 are compressible closed cell foam disks that have a waistline indentation 52 to secure them in the cloning lids 42 and a slit 54 to support and constrain the plant about its stalk (FIG. 12.)

The in line filter 14 is after the pump 12 but before the valve 16. To drain the system requires the valve 16 to be shut, the filter 14 unscrewed, a garden hose attached to the filter 14 and the pump 12 run. Additions of fluid media is done into the vessel 10. Removal of the lids (42 or 44) allows the cleaning or disinfection of the system components while replacement of the spinners 40 or adjustment of the spray header 24 may be done via the access ports 49.

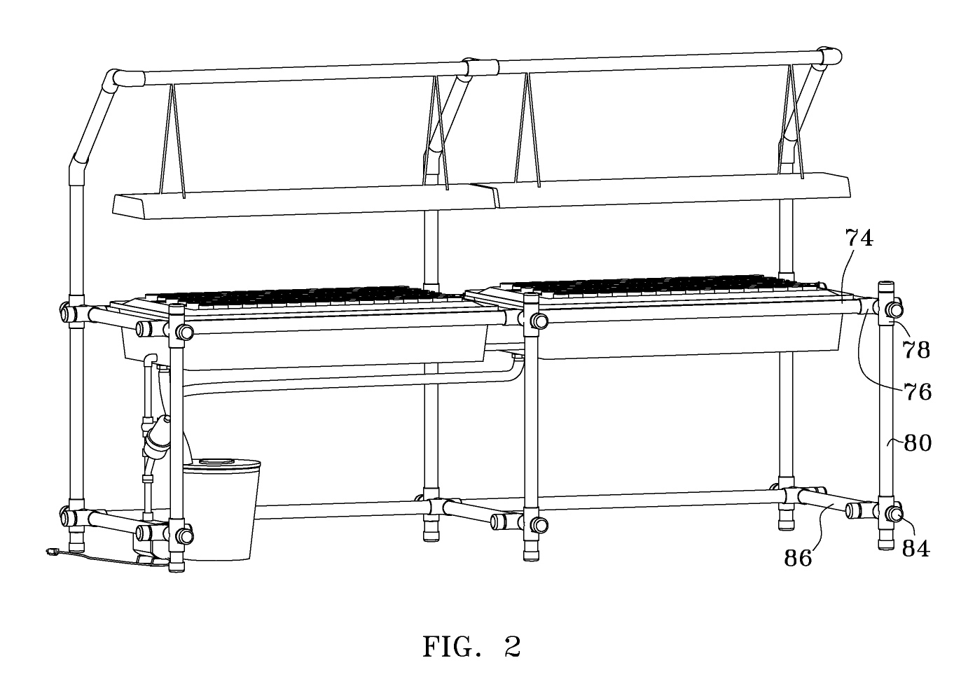

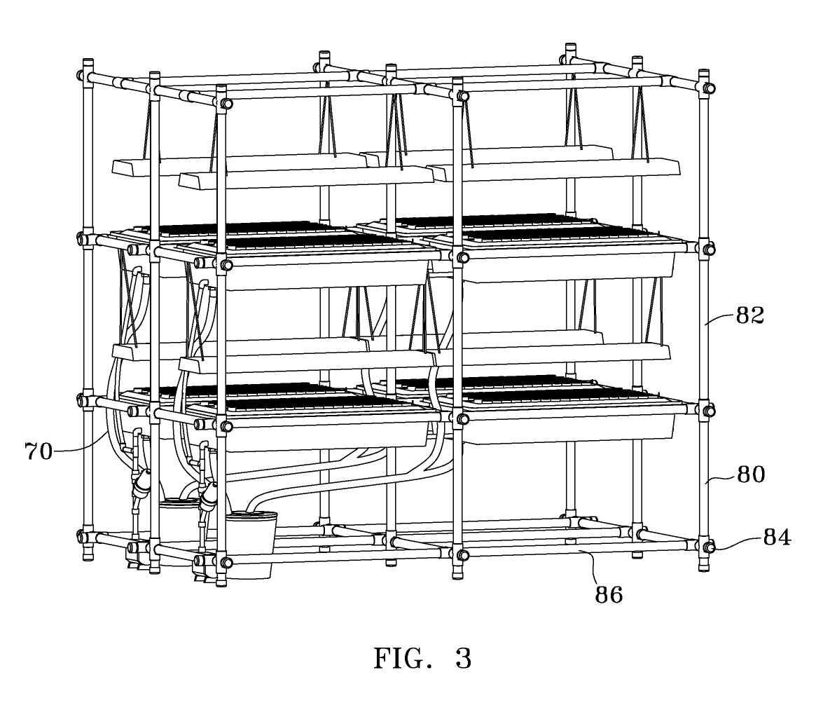

The support structure is made from matingly engagable tubing, caps, elbows, tees and crosses. The configuration thereof is designed to allow the coupling of additional systems thereto either horizontally, (FIG. 2) vertically or both (FIG. 3.) In these configurations it has been shown that a single pump 12 can supply adequate fluid media pressure and volume to maintain multiple units although balancing valves will be needed at various points of the piping/tubing discharge runs 70.

The general support structure 2 has an upper rectangular configuration 74 of tubing joined at each of the corners by first cross fittings 76. A second cross fitting 78 is affixed to one of the first cross fitting's bu a short section of tubing (not visible.) This second cross fitting holds a lower leg 80 and can also hold an upper leg 82 if double stacking of systems is utilized (FIG. 3.) This second cross fitting 78 also may be connected to another system located horizontally adjacent. On the bottom of the lower leg 80 is a third cross fitting 84 that holds leg stabilizer tubes 86. It is to be noted that there is no front leg stabilizer bars so that the system is wheelchair accessible.

It is to be noted that the second and third cross fittings may also replaced by tee fittings where connection to additional systems is not intended.

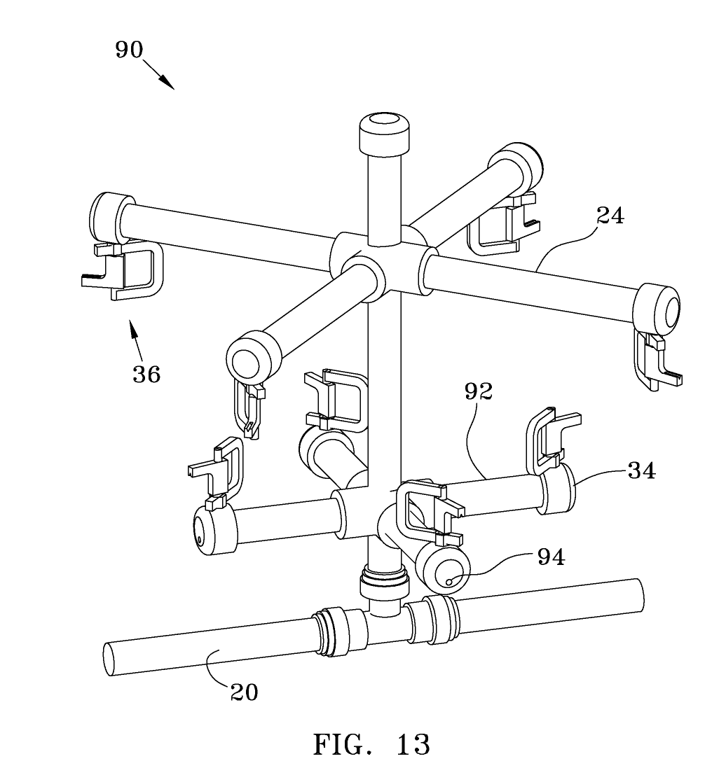

The essential element to the rapid growth rates achieved with this system is the ability of the spray headers to both saturate all 360 degrees of the vegetative root and to maximize the amount of oxygen in the fluid media that the spray header saturates the roots with. FIG. 13 shows an alternate embodiment spray header 90. Here can be seen that a small spray header 92 with optional orifices 94 in the caps 34 has been added. Additionally (and optionally) the spinnable spray nozzles 36 on the larger (upper) spray header 24 have been oriented to face downward. This alternate embodiment configuration has applications where there are longer or larger roots as would be found in mature vegetation. In such situations to ensure the continued coverage of a 360 degree root spray additional locations of fluid media spray must be used. The optional orifices 94 that are on the lower small spray header 92 reside in close proximity to the bottom of the sloped enclosure 4 where the fluid media runs back to the drain tube. The stream of fluid media that passes through this orifice 94 sprays into this returning fluid media thereby increasing the overall oxygen content of the fluid media. It is known that there is a plethora of physical configurations of the spray headers with regard to sizes, and spray nozzle placements and orifice locations that can be established from this generic configuration.

In operation the user need sterilize all the system as is well known in the field, mix the appropriate fluid media of water, nutrients and desired additives and fill the collection vessel 10 with the media, place vegetative cuttings into the slot 54 of the cloning pucks 50, place the cloning pucks into the cloning lid 42, place the spray header 24 in the cloning pattern and start the grow light 64 and pump 12.

When the clones reach an appropriate size they are removed and the vegetative/flowering stage lid 44 replaces the cloning lid and either pots with rock or plant netting is placed into the plant orifices 48 with a reduced number of plants put into the lid 44. The spray header's pattern is adjusted, the fluid media chemistry is adjusted and the system 2 is started up again with the user's desired changes implemented to the spray cycles and light cycles.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. An expandable, modular aeroponic vegetative grow system comprising:
an expandable tubular support structure;
an opaque, openable enclosure;
piping;
a collection vessel;
an in line pump;
a distribution manifold residing within said enclosure;
at least one rotatable spray header operably connected to said distribution manifold;
at least one spray nozzle extending from said spray header;
wherein said enclosure is supported by said structure and said piping operably connects said enclosure to said vessel and said vessel to said pump and said pump to said distribution manifold so as to enable the circulation of a fluid growing media from a bottom of said enclosure to an outlet of said spray nozzle.

2. The expandable, modular aeroponic vegetative grow system of claim 1 wherein said spray nozzle is a spinable spray nozzle.

3. The expandable, modular aeroponic vegetative grow system of claim 2 wherein said openable enclosure has a leakproof drip tray and at least one interchangeable lid adapted for leakproof sealing of said drip tray so as to form a leakproof cavity therein.

4. The expandable, modular aeroponic vegetative grow system of claim 3 wherein said lid is generally planar and has at least one orifice formed therethrough.

5. The expandable, modular aeroponic vegetative grow system of claim 4 comprising at least one closed cell foam cloning puck matingly engageable in said orifice.

6. The expandable, modular aeroponic vegetative grow system of claim 5 wherein said cloning puck is generally planar with a slit formed therethrough for the suspension of a vegetation into said cavity.

7. The expandable, modular aeroponic vegetative grow system of claim 3 wherein said rotatable spray header is made of four tubes each with a distal sealed end and an open proximate end that extends into a cross fitting that has a connection riser extending normally and centrally therefrom a bottom face of said cross fitting and connecting to said distribution manifold, and wherein said tubes have a spray nozzle opening adjacent said distal end that matingly accepts said spray nozzle.

8. The expandable, modular aeroponic vegetative grow system of claim 7 wherein said cross fitting has a support peg extending from a top face up to a bottom side of said lid so as to support said lid.

9. The expandable, modular aeroponic vegetative grow system of claim 7 further comprising:
an in line filter connected between said pump and said distribution manifold;
a drain fitting on said tray that connects said tray to said piping that operably connects said enclosure to said vessel.

10. The expandable, modular aeroponic vegetative grow system of claim 9 comprising a valve positioned in said piping between said filter and said distribution manifold.

11. The expandable, modular aeroponic vegetative grow system of claim 7 wherein the number of rotatable spray headers is three.

12. The expandable, modular aeroponic vegetative grow system of claim 3 wherein said expandable tubular support structure has a four corner upper rectangular frame that supports said tray, and has a first cross fitting connector at each said corner that is connected to a second cross fitting connector that is connected to a first leg, said second cross fitting connector adapted for connection to a second leg of a second substantially similar modular aeroponic vegetative grow system placed vertically adjacent said modular aeroponic vegetative grow system, and wherein said first cross fitting connector is adapted for connection to a first cross fitting connector of a substantially similar second modular aeroponic vegetative grow system placed horizontally adjacent said modular aeroponic vegetative grow system.

13. The expandable, modular aeroponic vegetative grow system of claim 12 wherein said distribution manifold has a first end connected to said piping and a second end with a removable cap affixed thereto and residing adjacent to a removably sealed through passage in a side wall of said tray.

14. The expandable, modular aeroponic vegetative grow system of claim 13 wherein said enclosure is made of a medical grade polymer.

15. The expandable, modular aeroponic vegetative grow system of claim 12 further comprising a light support residing above said enclosure and connected to said first cross tee fitting connectors that reside at a front corner of said upper rectangular frame.

16. The expandable, modular aeroponic vegetative grow system of claim 11 wherein said expandable tubular support structure has a four corner upper rectangular frame that supports said tray, and has a first cross fitting connector at each said corner that is connected to a first tee fitting connector that is connected to a first leg, said first tee fitting connectors on said rear corners of said rectangular frame are each connected to a light support tube leg that supports a light support tube that resides vertically adjacent said modular aeroponic vegetative grow system enclosure.

17. An aeroponic vegetative grow system comprising:
an opaque, openable enclosure;
piping;
a submersible pump residing within said enclosure;
a rotatable spray header;
at least one spray nozzle extending from said spray header;
a distribution riser operably connected between said pump and said spray header;
whereas said pump can enable the circulation of a fluid growing media from a bottom of said enclosure to an outlet of said spray nozzle.

18. The aeroponic vegetative grow system of claim 17 wherein a fluid pressure generated by said pump when it circulates said fluid media causes said spinable spray nozzle to spin in a circular pattern to fling out said media into said enclosure.

19. The aeroponic vegetative grow system of claim 17 further comprising an in line filter operably connected to said pump.

20. An aeroponic vegetative grow system comprising:
an aeroponic enclosure;
a fluid pumping means;
at least one positionable spray header configured into a cross with rotatably spray nozzles extending normally therefrom.
